(19) United States
(12) Patent Application Publication
(10) Pub. No.: US 2014/0259643 A1
(43) Pub. Date: Sep. 18, 2014

(54) METHOD OF APPLYING A STRESS RELIEVING MATERIAL TO AN EMBEDDED MAGNETIC COMPONENT

(71) Applicant: Mlti-Fineline Electronicx,m Inc., Irvine, CA (US)

(72) Inventor: Ciprian Marcoci, Placentia, CA (US)

(73) Assignee: MULTI-FINELINE ELECTRONIX, INC., Irvine, CA (US)

(21) Appl. No.: 14/112,979

(22) PCT Filed: Mar. 15, 2013
(86) PCT No.: PCT/US2013/032667

§ 371 Date: Oct. 21, 2013

Related U.S. Application Data
(60) Provisional application No. 61/706,959, filed on Sep. 28, 2012.

(51) Int. Cl. H01F 41/02

(52) U.S. Cl. CPC H01F 41/02
USPC 29/607

(57) ABSTRACT

A method of manufacturing a substrate includes providing a substrate with a cavity and a post in the cavity, dispensing an elastic filling material in the cavity, inserting a magnetic core including a core hole such the post extends through the core hole, curing the elastic filling material, forming holes in the substrate outside of the cavity and in the post, and forming via-in-via structures in the holes.

### BACKGROUND OF THE INVENTION

1. Field of the Invention

The present invention relates to substrates with an embedded magnetic component. More specifically, the present invention relates to substrates with an embedded magnetic component surrounded by stress relieving material.

2. Description of the Related Art

It is known to provide a transformer by embedding a magnetic core 206, also referred to as a ferrite core, in a printed circuit board 202 and by using conductors 208 and vias 210 to form windings around the magnetic core 206, as shown, for example, in FIG. 21 of this application which corresponds to a figure from U.S. Pat. No. 8,203,418.

U.S. Pat. No. 8,203,418 provides an integrated planar transformer and electronic component that includes at least one wideband planar transformer disposed in a planar substrate. U.S. Pat. No. 8,203,418 uses cylindrical cavities 204 to hold the magnetic cores 206. The magnetic cores 206 have an annular shape with a hole in the middle. The hole in the middle of the magnetic cores 206 is filled with an epoxy material with vias drilled through the epoxy material. The cavities 204 in U.S. Pat. No. 8,203,418 are cylindrical so that the center portion of the magnetic cores 206 is supported by the epoxy material and is exposed to lamination loads, which are the compressive loads applied to the planar substrate and the magnetic cores 206 when the different layers are bonded during a lamination process. Because the center portion of the magnetic cores 206 is epoxy, it is difficult to create vias in the center portion of the magnetic cores 206. Mismatches in the coefficient of thermal expansion (CTE) of the materials used in the planar substrate and the center core will create thermal stresses that will result in the failure of the vias and/or the dielectric materials used therein.

U.S. Pat. No. 7,271,697 provides miniature circuitry and inductor components in which multiple layers of printed circuitry are formed on each side of a planar substrate. U.S. Pat. No. 7,271,697 uses a pre-impregnated composite fiber material (prepreg material) to fill the space surrounding the magnetic core. The prepreg material is used in U.S. Pat. No. 7,271,697 because it facilitates the manufacturing process and because the coefficient of thermal expansion of the prepreg material is the same as the planar substrate because the prepreg and planar substrate are made from the same materials. However, the inventors of the present application have subsequently discovered that the prepreg material conforms to the space during lamination and imparts a certain amount of pressure on the magnetic core, which can negatively affect the magnetic permeability properties of the magnetic core due to magnetostriction.

U.S. Patent Application Publication No. 2008/0816124 teaches a wireless inductive device and methods of manufacturing such an inductive device. The manufacturing methods in U.S. Patent Application Publication No. 2008/0816124 include forming conductors on two substrates (top and bottom) and joining the two substrates with a magnetic core between the two substrates to create an inductive device. U.S. Patent Publication No. 2008/0816124 does not use a cushioning material to prevent the compression of the magnetic core during the manufacturing process, which can lead to damage of the magnetic core and can also negatively affect the magnetic permeability properties of the magnetic core due to magnetostriction.

U.S. Pat. No. 8,234,778 teaches substrate inductive devices and methods to make an inductive device comprised of three substrates: top, bottom, and middle. The top and bottom substrates contain conductors and the middle substrate contains a magnetic core(s) with electrical connectors. The three substrates are joined or assembled to create the device. This arrangement is difficult to manufacture in mass production and provides lower via hole density.

### SUMMARY OF THE INVENTION

To overcome the problems described above, preferred embodiments of the present invention provide a method of providing substrate with an embedded magnetic component that is surrounded by a stress relieving material that protects the magnetic component against mechanical stress and that eliminates magnetostriction effects on the magnetic component.

A method of manufacturing a substrate according to a preferred embodiment of the present invention includes providing a substrate with a cavity and a post in the cavity, dispensing an elastic filling material in the cavity, inserting a magnetic core including a core hole such the post extends through the core hole, curing the elastic filling material, forming holes in the substrate outside of the cavity and in the post, and forming via-in-via structures in the holes.

The method preferably further includes forming conductors connected to the via-in-via structures. The conductors and the via-in-via structures preferably provide primary and secondary windings of a transformer.

A method of manufacturing a substrate according to a preferred embodiment of the present invention includes providing a substrate with a cavity and a post in the cavity, inserting a magnetic core including an elastic filing material coating and a core hole such that the post extends through the core hole, forming holes in the substrate outside of the cavity and in the post, and forming via-in-via structures in the holes.

The method preferably further includes providing a prepreg ring or rings in the cavity before the step of inserting the magnetic core. The method preferably further includes forming conductors connected to the via-in-via structures. The conductors and the via-in-via structures preferably provide primary and secondary windings of a transformer.

The step of forming via-in-via structures preferably includes forming a metal layer in the holes. The step of forming via-in-via structures preferably further includes forming an insulating coating over the metal layer in the holes. The step of forming via-in-via structures preferably further includes forming a metal layer over the insulating coating.

The above and other features, elements, steps, characteristics and advantages of the present invention will become more apparent from the following detailed description of preferred embodiments of the present invention with reference to the attached drawings.

### BRIEF DESCRIPTION OF THE DRAWINGS

FIGS. 1-12 show a method of manufacturing a substrate with an embedded magnetic component according to a first preferred embodiment of the present invention.

FIG. 1 is perspective view of a substrate 10 with a cavity 11.

FIG. 2 is sectional side view showing a magnetic core 14 being inserted into a cavity 11.

FIG. 3 is perspective view of the substrate 10 with the magnetic core 14.

FIG. 4 is a sectional side view showing a copper foil 15 laminated to the substrate 10.

FIG. 5 is a sectional side view showing via holes 16 drilled in the substrate 10.

FIG. 6 is a sectional side view showing a copper plating 17 on the substrate 10 and inside via holes 16.

FIG. 7 is a perspective view showing conductors 18 on the substrate 10.

FIG. 8 is a side sectional view showing a parylene coating 19 on the substrate 10.

FIG. 9 is a side sectional view showing a predrilled adhesive 20a and copper layer 20b laminated on the substrate 10.

FIG. 10 is a side sectional view showing via hole openings 21 being formed in copper foil 20b on the substrate 10.

FIG. 11 is a side sectional view showing copper plating 22 formed on the substrate 10 and inside via holes 16.

FIG. 12 a perspective view showing conductors 23 formed on the substrate 10.

FIGS. 13-20 show a method of manufacturing a substrate with an embedded magnetic component according to a second preferred embodiment of the present invention.

FIG. 13 is perspective view of a substrate 30 with a cavity 31.

FIG. 14 is sectional side view showing a magnetic core 34 being inserted into the cavity 31.

FIG. 15 is perspective view of the substrate 30 with the pre-coated magnetic core 34.

FIG. 16 is a sectional side view showing a prepreg layer 34b and a copper foil 35 on the substrate 30.

FIG. 17 is a sectional side view showing the prepreg layer 34b and the copper foil 35 laminated to the substrate 30.

FIG. 18 is a sectional side view showing via holes 36 drilled in the substrate 30.

FIG. 19 is a sectional side view showing a copper plating 37 on the substrate 30 and inside via holes 36.

FIG. 20 is a perspective view showing conductors 38 on the substrate 30.

FIG. 21 shows a known method of embedding a magnetic core in a printed circuit board.

### DETAILED DESCRIPTION OF PREFERRED EMBODIMENTS

FIGS. 1-12 show a method of manufacturing a substrate with an embedded magnetic component according to a first preferred embodiment of the present invention. FIGS. 13-20 show a method of manufacturing a substrate with an embedded magnetic component according to a second preferred embodiment of the present invention.

In contrast to U.S. Pat. No. 8,203,418, preferred embodiments of the present invention include a toroidal cavity including a support post of the planar substrate disposed in the middle of the toroidal cavity. The support post reduces the lamination loads on a magnetic core. In preferred embodiments of the present invention, the vias in the center of the magnetic core are formed in the support post of the planar substrate, and are not formed in an epoxy material as with U.S. Pat. No. 8,203,418. Because the vias are formed in the support post instead of an epoxy material in preferred embodiments of the present invention, the vias can be more reliably formed. Because the vias are disposed in the mostly homogeneous material of the planar substrate, thermal stresses are significantly reduced and prevented because there is no mismatch in coefficients of thermal expansion between the planar substrate and the epoxy material. The toroidal cavity significantly reduces and prevents any stresses from acting on the magnetic cores. The support post of the planar substrate will absorb the compressive loads imparted during laminating of the circuit layers so as to significantly reduce the compressive forces applied to the magnetic core.

Preferred embodiments of the present invention solve the problems with the method of U.S. Pat. No. 7,271,697 by reducing the loads imposed on the magnetic core during the manufacturing steps of forming the transformer. Preferred embodiments of the present invention use a precise volume of elastic filling material dispensed in the space surrounding the magnetic core to prevent the compression of the magnetic material and to eliminate voids. Voids are known to result in delamination during the manufacturing process. The elastic filling material is preferably a silicon material with a low viscosity; however, other suitable materials, including other elastomeric materials that can withstand the conditions, such as the temperature, of the manufacturing process, can also be used. Typically, the volume of elastic filling material is determined before manufacturing begins. The volumes of the cavity and the magnetic cores can be determined using, for example, surface scans. Then, the volume of the elastic filling material can be determined by subtracting the volume of the magnetic core from the volume of the cavity, while considering the properties of the elastic filling material such as expansion or contraction during any curing process. The volume of the elastic filling material is preferably precisely determined because too much elastic filling material can cause cracking. The volume of the elastic filling material is equal to or substantially equal, within manufacturing tolerances, to the volume of the cavity minus the volume of the magnetic core. Manufacturing tolerances include the tolerances associated with the forming of the cavity and the magnetic core and with the specific properties of the type of elastic filling material used.

By using a controlled volume of elastic filling material, preferred embodiments of the present invention ensure that the elastic filling material is located only in the space surrounding the magnetic core and does not migrate to the areas of the circuit where the vias will be formed. The volume of the elastic filling material to be dispensed is equal or substantially equal to the volume of the toroidal cavity minus the volume of the magnetic core. Using automatic dispensing equipment to apply the elastic filling material eliminates the possibility of over/under filling of the cavity containing the magnetic cores. This also prevents the elastic filling material from migrating to the via hole areas.

The preferred embodiments of the present invention include methods of embedding a magnetic material in a planar substrate. More specifically, the preferred embodiments of the present invention include methods of embedding magnetic cores within a printed circuit board or a rigid flex circuit. The methods of the preferred embodiments of the present invention achieve a high-yield manufacturing process for creating miniature circuits with high functional reliability and with embedded magnetic cores for an inductor or a transformer. The embedding process and circuit configuration enable efficient and repeatable manufacturing of miniature circuits and miniature magnetic devices having high-voltage, high-current capabilities, as well as high tolerance to physical stress. The elastic filling material used to fill the toroidal cavity protects the magnetic core against mechanical stress and eliminates magnetostriction effects on the magnetic core.

Some preferred embodiments of the present invention preferably include a via-in-via structure in which vias share the same via hole, which significantly reduces and prevents leakage inductance between the primary and secondary windings of a transformer and which can reduce the total number of via holes, which provides for further miniaturization. U.S. Pat. No. 8,203,418 B2 and/or U.S. Patent Publication No. 2008/0186124 A1 do not use a via-in-via structure, and thus cannot achieve the higher routing density made possible by the via-in-via structure.

In the preferred embodiments of the present invention that use a via-in-via structure, multiple coaxial independent conductors are fabricated on the wall of the via hole drilled in the planar substrate near the magnetic core. The planar substrate is typically a printed circuit board or rigid flex circuit. The printed circuit board can be made of FR-4 epoxy laminate sheets or any other suitable material. Any suitable materials can be used including polyimide-based clad, copper-clad polyimide, epoxy, acrylic adhesives, copper-clad epoxy laminates, for example.

FIGS. 1-12 show a method of manufacturing a substrate with an embedded magnetic component according to a first preferred embodiment of the present invention.

To manufacture a substrate with an embedded magnetic component according to a first preferred embodiment of the present invention, a substrate 10 is provided. Substrate 10 preferably has a planar shape. Substrate 10 is typically a printed circuit board, e.g., an FR-4 epoxy-laminated sheet(s). As shown in FIG. 1, a cavity 11 is formed in the substrate 10 using a numerically controlled (NC) controlled-depth routing machine. The cavity 11 preferably has a toroidal shape with a post 12 in the center of the cavity 11. It is possible to use any other suitable method of creating the cavity, including embossing and molding, for example. The possible methods that can be used depend on the type of substrate used. Instead of having a circular perimeter, the perimeter of the cavity 11 can have any suitable shape, including an oval or a square shape, for example.

Next, as shown in FIG. 2, an elastic filling material 13 is dispensed into the cavity 11 using controlled-volume automatic-dispensing equipment. The elastic filling material 13 is preferably a low-viscosity silicon material. Any other elastomeric materials that can withstand the conditions, such as the temperature, of the manufacturing process, can also be used.

A magnetic core 14 is inserted into the cavity 11. A pick-and-place equipment is preferably used; however, the magnetic core 14 can be inserted into the cavity 11 using any suitable method, including manual insertion. The magnetic core 14 is typically a ferrite; however, other suitable magnetic permeable materials could also be used, such as powdered-iron core, for example. The choice of materials for the magnetic core 14 affects what type of materials can be used for the elastic filling material 13.

Additional elastic filling material 13 is dispensed on top of the magnetic core 14. The additional elastic filling material 13 is dispensed using the same controlled-volume automatic-dispensing equipment used to dispense the original elastic filling material 13 in the empty cavity 11. However, different equipment can be used to dispense the additional elastic filling material 13.

All of the elastic filling material 13 is then thermally cured. The conditions, including time and temperature, for thermally curing the elastic filling material depend on the material used for the elastic filling material. The curing results in the substrate 10 with the magnetic core 14 inserted into the cavity 11 as shown in FIG. 3.

Copper foils 15 are laminated on the top and bottom surface of the substrate 10 as shown in FIG. 4. The copper foils 15 are preferably laminated using a vacuum lamination process; however other suitable processes could also be used. Although laminating copper is preferred, it is possible to use other suitable conductive materials and to use other suitable methods of providing the conductive materials. For example, instead of using copper, it is possible to use other conductive materials such as silver or aluminum, and instead of laminating copper, it is possible print conductive inks.

FIG. 5 shows via holes 16 drilled into the substrate 10 around the magnetic core 14 and in the post 12. The via holes 16 are preferably drilled using an NC drilling machine; however, the via holes 16 can be formed using any suitable method or machine.

FIG. 6 shows plating the top and bottom surfaces of the substrate 10 and the via holes 16 with copper plating 17.

In FIG. 7, conductors 18 are formed on the top and bottom surfaces of the substrate 10. The conductors 18 are preferably printed and etched using standard PCB processes. The conductors 18 can be used, for example, as the windings of a transformer.

Next, as shown in FIG. 8, a parylene coating 19 is applied on the top and bottom surfaces of the substrate 10 and inside the via holes 16 to form an insulator so that a via-in-via structure can be formed. Epoxies, polymers, liquid polyamide, or any other insulating materials can be used instead of parylene.

As shown in FIG. 9, a predrilled adhesive and copper layer 20 is laminated on top and bottom surfaces of the substrate 10. The predrilled adhesive and copper layer 20 is preferably laminated using vacuum lamination; however, other suitable processes could be used.

Via hole openings 21 are formed on the top and bottom surfaces of the substrate 10 as shown in FIG. 10. The via hole openings 21 are preferably printed and etched using standard PCB processes.

The, as shown in FIG. 11, copper plating 22 is plated on the top and bottom surfaces of the substrate 10 and inside via holes 16 to form the via-in-via structure.

Finally, conductors 23 are formed in FIG. 12 on the top and bottom surfaces of the substrate 10. The conductors 23 are preferably printed and etched using standard PCB processes. The conductors 23 can be the secondary windings of a transformer with a turns ratio of 5:1.

FIGS. 13-20 show a method of manufacturing a substrate with an embedded magnetic component according to a second preferred embodiment of the present invention. One of the differences between the first and second preferred embodiments of the present invention is that magnetic core 34 is pre-coated with an elastic material and pre-impregnated (prepreg) rings are used to fill the cavity 31. The second preferred embodiment eliminates the elastic filling material 13 dispensing step and the curing step and prevents getting silicone on the surfaces of the substrate 30, which increases yields.

To manufacture a substrate with an embedded magnetic component according to a second preferred embodiment of the present invention, a substrate 30 is provided. As with substrate 10, substrate 30 preferably has a planar shape. Substrate 30 is typically a printed circuit board, e.g. an FR-4 epoxy-laminated sheet(s). As shown in FIG. 13, a cavity 31 is formed in the substrate 30 using a NC controlled-depth routing machine. The cavity 31 preferably has a toroidal shape with a post 32 in the center of the cavity 31. It is possible to use any other suitable method of creating the cavity, including embossing and molding, for example. The possible methods that can be used depend on the type of substrate used. Instead of having a circular perimeter, the perimeter of the cavity 31 can have any suitable shape, including an oval or a square shape, for example.

Next, as shown in FIGS. 14 and 15, a magnetic core 34 with an elastic material coating 33 is provided. The elastic material coating 33 is preferably a low-viscosity silicon material. Any other elastomeric materials that can withstand the conditions, such as the temperature, of the manufacturing process, can also be used. Prepreg rings 34a are also provided. The prepreg rings 34a are preferably composite-fiber weave that is impregnated with a resin. The preferred materials are medium or high Tg epoxy prepregs.

The prepreg ring or rings 34a are inserted into the cavity 31, and then the magnetic core 34 is inserted into the cavity 31. Pick-and-place equipment is preferably used to insert the prepreg ring or rings 34a into the cavity 32; however, the prepreg ring or rings 34a can be inserted into the cavity 31 in any suitable manner, including manual insertion. Pick-and-place equipment is preferably used to insert the magnetic core 34a into the cavity 31; however, the magnetic core 34 can be inserted into the cavity 31 using any suitable manner, including manual insertion. The magnetic core 34 is typically a ferrite; however, other suitable magnetic permeable materials could also be used, such as powdered-iron core. The choice of materials for the magnetic core 34 affects what type of materials can be used for the elastic material coating 33.

The combination of a prepreg layer 34b layered on top of a copper foil 35 is preferably laminated to the top of the substrate 30 as shown in FIG. 16. The prepreg ring 34a and prepreg layer 34b are preferably made of the same material. As shown in FIG. 17, the prepreg layer 34b and the copper foil 35 are preferably laminated to the top surface of the substrate 30 under a prescribed pressure and at prescribed temperature. Other suitable processes could also be used. Although laminating copper is preferred, it is possible to use other suitable conductive materials and to use other suitable methods of providing the conductive materials. For example, instead of using copper it is possible to use other conductive materials such as silver or aluminum, and instead of laminating copper, it is possible to print conductive inks. Epoxy adhesives can also be used to laminate the copper foil 35 to the substrate 30. During the lamination process, the melted resin from the prepreg ring 34a and the prepreg layer 34b fill the voids in the cavity between the magnetic core 34 and the substrate 30.

FIG. 18 shows via holes 36 drilled into the substrate 30 around the magnetic core 34 and in the post 32. The vial holes 36 are preferably drilled using an NC drilling machine; however, the via holes 36 can be formed using any suitable method or machine.

FIG. 19 shows plating the top and bottom surfaces of the substrate 30 and the via holes 36 with copper plating 37.

In FIG. 20, conductors 38 are formed on the top and bottom surfaces of the substrate 30. The conductors 38 are preferably printed and etched using standard PCB processes. The conductors 38 can be used, for example, as the windings of a transformer.

The via-in-via structure can be formed in substrate 30 using the steps discussed above for FIGS. 8-12.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. A method of manufacturing a substrate comprising:
providing a substrate with a cavity and a post in the cavity;
dispensing an elastic filling material in the cavity;
inserting a magnetic core including a core hole such the post extends through the core hole;
curing the elastic filling material;
forming holes in the substrate outside of the cavity and in the post; and
forming via-in-via structures in the holes.

2. A method of claim 1, further comprising forming conductors connected to the via-in-via structures.

3. A method of claim 2, wherein the conductors and the via-in-via structures provide primary and secondary windings of a transformer.

4. A method of claim 1, wherein the step of forming via-in-via structures includes forming a metal layer in the holes.

5. A method of claim 4, wherein the step of forming via-in-via structures further includes forming an insulating coating over the metal layer in the holes.

6. A method of claim 5, wherein the step of forming via-in-via structures further includes forming a metal layer over the insulating coating.

7. A method of manufacturing a substrate comprising:
providing a substrate with a cavity and a post in the cavity;
inserting a magnetic core including an elastic filling material coating and a core hole such that the post extends through the core hole;
forming holes in the substrate outside of the cavity and in the post; and
forming via-in-via structures in the holes.

8. A method of claim 7, further comprising providing a prepreg ring or rings in the cavity before the step of inserting the magnetic core.

9. A method of claim 7, further comprising forming conductors connected to the via-in-via structures.

10. A method of claim 9, wherein the conductors and the via-in-via structures provide primary and secondary windings of a transformer.

11. A method of claim 7, wherein the step of forming via-in-via structures includes forming a metal layer in the holes.

12. A method of claim 11, wherein the step of forming via-in-via structures further includes forming an insulating coating over the metal layer in the holes.

13. A method of claim 12, wherein the step of forming via-in-via structures further includes forming a metal layer over the insulating coating.

14. A method of claim 1, wherein the elastic filling material includes a low-viscosity silicone material.

15. A method of claim 1, wherein the elastic filling material includes a silicone material.

16. A method of claim 7, wherein the elastic filling material coating includes a low-viscosity silicone material.

17. A method of claim 7, wherein the elastic filling material coating includes a silicone material.
